(19) United States
(12) Patent Application Publication
(10) Pub. No.: US 2009/0226699 A1
(43) Pub. Date: Sep. 10, 2009

(54) SINTERED BODY AND MEMBER USED FOR PLASMA PROCESSING APPARATUS

(75) Inventors: Yukitaka MURATA, Tokyo (JP); Keisuke Watanabe, Tokyo (JP)

Correspondence Address: FOLEY AND LARDNER LLP;SUITE 500, 3000 K STREET NW, WASHINGTON, DC, 20007, US

(73) Assignee: COVALENT MATERIALS CORPORATION

(21) Appl. No.: 12/394,943

(22) Filed: Feb. 27, 2009

(30) Foreign Application Priority Data
Feb. 28, 2008 (JP) 2008-046996
Mar. 28, 2008 (JP) 2008-085440

(51) Int. Cl. C04B 35/50; B32B 18/00; B32B 3/26

(52) U.S. Cl. 428/312.8; 501/152; 428/409

(57) ABSTRACT

The present invention aims to provide a sintered body and a component used in a plasma processing apparatus. The sintered body and the component are mainly composed of a cerium oxide, which is excellent in corrosion resistance to halogen-based gas or plasma, and can reduce resistance. The cerium oxide can also suppress contamination of metal due to impurity caused by the constituent material of the ceramic even in a halogen plasma process, so that it can preferably be used, as a substitute of an yttria, for a component in a plasma processing apparatus for manufacturing a semiconductor or liquid crystal.

A sintered body is used, wherein at least the portion exposed to plasma is formed by adding an yttria with a purity of 99% or more in an amount of 3 parts by weight or more and 100 parts by weight or less to 100 parts by weight of a cerium oxide having purity of 99% or more. Alternatively, a component covered by a sprayed film having the composition same as described above is used. Alternatively, a sintered body that is formed by adding a lanthanum oxide with a purity of 99% or more to a cerium oxide with a purity of 99% or more in an amount of 1 to 50 mol % in the total composition is used, wherein the surface roughness Ra of the portion at least exposed to plasma is less than 1.6 μm.

### BACKGROUND OF THE INVENTION

1. Field of the Invention

The present invention relates to a sintered body and a component that can preferably be used for a plasma processing apparatus, such as an apparatus for fabricating a semiconductor or liquid crystal.

2. Description of the Related Art

In a semiconductor manufacturing apparatus, components in the apparatus in an etching process, a CVD film-forming process, an ashing process for removing a resist, in which a plasma process is a mainstream, are exposed to plasma of halogen gas, such as fluorine or chlorine having high reactivity.

Therefore, a ceramic such as high-purity alumina, aluminum nitride, yttria (yttria oxide), YAG, etc., is used for the components exposed to the halogen plasma in the above-mentioned processes (refer to, for example, Japanese Patent Application Laid-Open No. 2000-247726).

Among the materials described above, the yttria ceramic is excellent in resistance to plasma, so that it is conventionally used in a plasma processing apparatus as a single sintered body.

However, the yttria ceramic has high volume resistivity, such as 10¹³ Ωcm. Therefore, a special tuning is needed in order to employ the yttria ceramic as a substitute of a silicon component or the like. Further, in some cases, the yttria ceramic cannot be used, since it hinders the generation of plasma or entails non-uniform plasma. Moreover, the yttria ceramic is easy to be charged, so that it attracts reaction products to thereby cause dusts.

To this problem, there has been proposed a method of adding a metal or a metal oxide such as titanium oxide or tungsten oxide, metal nitride such as titanium nitride, or metal carbide such as titanium carbide, tungsten carbide, or silicon carbide, those of which exhibit conductivity, in order to reduce the volume resistivity of the yttria ceramic.

However, when a component to which a metal or the like is added in order to reduce the volume resistivity of the yttria sintered body is used for the plasma processing apparatus, a dielectric loss is increased due to this component, which loses energy during the plasma processing. In some cases, the component might generate heat to be broken.

The yttria sintered body having a metal or the like added thereto not only reduces the resistance to plasma, but also might entail a wafer contamination due to an impurity element in some cases.

Accordingly, a demand to reduce contamination of the processed wafer due to the impurity from the yttria sintered body used in the plasma processing apparatus, particularly a demand to reduce contamination of yttrium, has been increased.

The abundance of yttrium, which is a constituent element of yttria, on earth is small among rare earths, so that the yttrium is very expensive. Therefore, the sintered body using the yttria has increased cost.

In view of this, a material that is excellent in resistance to plasma, and can be obtained with lower cost compared to the yttria has been demanded.

The present inventors have conducted researches about a material, which can be replaced with the yttria used in the plasma processing apparatus, in order to solve the above-mentioned technical problem, and have paid attention to a cerium, whose abundance is the greatest among the rare earths, and which is relatively cheap.

A cerium oxide (herein after sometimes referred to as ceria) is used for an abrasive compound in a CMP process of a wafer or a colored component of a glass, which means that the cerium has been actually used in a use application of a semiconductor. Further, the cerium oxide has resistance to plasma, and is a promising material for reducing the volume resistivity.

### SUMMARY OF THE INVENTION

The present invention aims to provide a sintered body and a component used in a plasma processing apparatus. The sintered body and the component are mainly composed of a cerium oxide, which is excellent in corrosion resistance to halogen-based corrosive gas or plasma, and can reduce resistance. The cerium oxide can also suppress contamination of metal due to impurity caused by the constituent material of the ceramic even in a halogen plasma process, so that it can preferably be used for a component in a plasma processing apparatus for manufacturing a semiconductor or liquid crystal.

The sintered body used in the plasma processing apparatus according to the present invention is formed by adding an yttria with a purity of 99% or more in an amount of 3 parts by weight or more and 100 parts by weight or less to 100 parts by weight of a cerium oxide having a purity of 99% or more. In other words, the sintered body used in the plasma processing apparatus according to the present invention is formed by adding an yttria with a purity of 99% or more to a cerium oxide with a purity of 99% or more in an amount of 2.3 mol % or more and 43.2 mol % or less in the total composition.

When the ceria ceramic having the yttria added thereto is used, the contamination of metal by an impurity caused by the constituent material of the sintered body can be suppressed, while maintaining the resistance to plasma. Further, the generation of dusts caused by an etching when the sintered body is used for the component in the plasma processing apparatus can be prevented.

A sintered body used in a plasma processing apparatus according to another aspect of the present invention is formed by adding an yttria with a purity of 99% or more to a cerium oxide with a purity of 99% or more in an amount of 1 mol % or more and 50 mol % or less in the total composition, and the surface roughness Ra of the portion at least exposed to plasma is less than 1.6 μm.

A sintered body used in a plasma processing apparatus according to still another aspect of the present invention is formed by adding a lanthanum oxide with a purity of 99% or more to a cerium oxide with a purity of 99% or more in an amount of 1 mol % or more and 50 mol % or less in the total composition, and the surface roughness Ra of the portion at least exposed to plasma is less than 1.6 μm.

When the ceria ceramic having the lanthanum oxide added thereto is used, the resistance is reduced, and the contamination of metal by an impurity caused by the constituent material of the sintered body can be suppressed, while maintaining the resistance to plasma. Further, the generation of dusts caused by an etching when the sintered body is used for the component in the plasma processing apparatus can be prevented.

It is preferable that the sintered body used in the plasma processing apparatus has porosity of 2% or less.

When the porosity falls within the above-mentioned range, the generation of dusts caused by an etching when the sintered body is used for the component in the plasma processing apparatus can be prevented.

It is also preferable that the sintered body used in the plasma processing apparatus has a volume resistivity of 10 to 10¹² Ωcm at 20 to 400° C.

Since the volume resistivity falls within the above-mentioned range, the generation of dusts by an etching can effectively be prevented. Further, the sintered body described above does not hinder the generation of plasma, and does not generate non-uniform plasma.

It is also preferable that the sintered body used in the plasma processing apparatus is sintered at 1600° C. or more and 1900° C. or less.

Since the sintering temperature falls within the above-mentioned range, the dense sintered body having sufficient strength can be formed.

According to another aspect, in the component used in the plasma processing apparatus according to the present invention, at least the portion exposed to plasma is covered by a plasma sprayed film formed by adding an yttria with a purity of 99% or more in an amount of 3 parts by weight or more and 100 parts by weight or less to 100 parts by weight of a cerium oxide having a purity of 99% or more, i.e., a plasma sprayed film formed by adding an yttria with a purity of 99% or more to a cerium oxide with a purity of 99% or more in an amount of 2.3 mol % or more and 43.2 mol % or less in the total composition.

When the ceria sprayed film having the yttria added thereto is formed on the portion exposed to plasma, the contamination of metal by an impurity caused by the sprayed material of the sprayed film can be suppressed, while maintaining the resistance to plasma.

It is preferable that, in the component used in the plasma processing apparatus, the porosity of the sprayed film is 5% or less.

When the porosity falls within the above-mentioned range, the generation of dusts caused by an etching when the component covered by the sprayed film is used in the plasma processing apparatus can be prevented.

As described above, the sintered body and the component used in the plasma processing apparatus according to the present invention is excellent in the corrosion resistance to halogen-based gas or plasma, can reduce resistance, and can suppress contamination of metal due to an impurity caused by the constituent material of the sintered body even in the halogen plasma process.

Consequently, the sintered body and the component according to the present invention can preferably be used for a component in a plasma processing apparatus in a manufacturing process of a semiconductor or liquid crystal, and further, can contribute to the enhancement of yield of a semiconductor chip or the like manufactured in the subsequent process.

### DESCRIPTION OF THE PREFERRED EMBODIMENTS

The sintered body and the component according to the present invention will be described below in more detail.

The sintered body used in the plasma processing apparatus according to a first embodiment of the present invention is formed by adding an yttria with a purity of 99% or more in an amount of 3 parts by weight or more and 100 parts by weight or less to 100 parts by weight of a cerium oxide having a purity of 99% or more. In other words, the sintered body used in the plasma processing apparatus is formed by adding an yttria with a purity of 99% or more to a cerium oxide with a purity of 99% or more in an amount of 2.3 mol % or more and 43.2 mol % or less in the total composition.

Specifically, the sintered body according to the first embodiment is formed by adding the yttria having resistance to plasma to the cerium oxide having resistance to plasma in a predetermined amount, whereby the resistance to plasma can be maintained, and even in a halogen plasma process, the contamination of a metal due to an impurity caused by the constituent material of the sintered body can be suppressed, compared to the conventional yttria ceramic sintered body.

A sintered body used in a plasma processing apparatus according to the second embodiment of the present invention is formed by adding an yttria with a purity of 99% or more to a cerium oxide with a purity of 99% or more in an amount of 1 mol % or more and 50 mol % or less in the total composition, and the surface roughness Ra of the portion at least exposed to plasma is less than 1.6 μm.

Specifically, the ceramic sintered body according to the second embodiment is formed by adding the yttria having resistance to plasma to the cerium oxide having resistance to plasma in a predetermined amount, whereby the volume resistivity is reduced, while maintaining the resistance to plasma, and even in a halogen plasma process, the contamination of a metal due to an impurity caused by the constituent material of the sintered body can be suppressed.

Accordingly, the sintered body can prevent the generation of dusts caused by the charged component in the plasma processing apparatus.

A sintered body used in a plasma processing apparatus according to the third embodiment of the present invention is formed by adding a lanthanum oxide with a purity of 99% or more to a cerium oxide with a purity of 99% or more in an amount of 1 mol % or more and 50 mol % or less in the total composition, and the surface roughness Ra of the portion at least exposed to plasma is less than 1.6 μm.

Specifically, the sintered body according to the third embodiment is formed by adding the lanthanum oxide having resistance to plasma to the cerium oxide having resistance to plasma in a predetermined amount, whereby the volume resistivity is reduced, while maintaining the resistance to plasma, and even in a halogen plasma process, the contamination of a metal due to an impurity caused by the constituent material of the ceramic sintered body can be suppressed.

Accordingly, the ceramic sintered body can prevent the generation of dusts caused by the charged component in the plasma processing apparatus.

High-purity powders with the purity of 99% or more are used for each of the materials of the cerium oxide, yttrium oxide, and lanthanum oxide, which are the compositions of the sintered body according to the first to the third embodiments.

When the purity is less than 99%, a sufficient dense sintered body cannot be formed. Further, when the sintered body is used for the component in the plasma processing apparatus, dusts might be generated due to the impurity in the material.

The additive amount of the yttria powders or the lanthanum oxide powders is 1 mol % or more and 50 mol % or less in the total composition of the sintered body.

When the additive amount is less than 1 mol %, the volume resistivity cannot sufficiently be reduced.

On the other hand, when the additive amount exceeds 50 mol %, the additive component becomes larger, so that the resistance is increased on the contrary.

It is preferable that at least the portion exposed to plasma in the sintered body has a surface roughness Ra of less than 1.6 μm. When the surface roughness Ra of the portion exposed to plasma is not less than 1.6 μm, the contact area of the component made of the sintered body in the plasma processing apparatus and the plasma increases, with the result that the component is easy to be etched.

Accordingly, a grinding process or the like is performed, as needed, in order that at least the surface of the portion exposed to the plasma in the sintered body has the surface roughness within the above-mentioned range.

It is also preferable that the porosity of the sintered body is 2% or less.

When the porosity exceeds 2%, dusts might be generated by the etching caused by residual pores in the sintered body, if the sintered body is used for the component in the plasma processing apparatus.

It is more preferable that the porosity is 1% or less.

It is also preferable that the volume resistivity of the sintered body is 10 to 10¹² Ωcm at 20 to 400° C.

When the volume resistivity exceeds 10¹² Ωcm, the sintered body is easy to be charged. Therefore, when the sintered body is used for the component in the plasma processing apparatus, it is difficult to prevent that the generation of the plasma is hindered or that the plasma is generated non-uniformly. Further, the generation of dusts cannot sufficiently be prevented.

As the volume resistivity decreases, the conductivity increases. In the composition of the sintered body according to the present invention, it is difficult in actuality that the volume resistivity is set to be less than 10 Ωcm.

It is preferable that the sintering process is performed under the temperature of not less than 1600° C. to not more than 1900° C. in order to form the sintered body described above.

When the sintering temperature is less than 1600° C., the ceramic has many remaining pores, which means that the sintered body that is sufficiently dense cannot be formed.

On the other hand, when the sintering temperature exceeds 1900° C., abnormal grain growth of crystal grains is likely to occur, so that the strength reduces.

The sintering temperature is more preferably within not less than 1700° C. and not more than 1850° C.

The sintered body according to the first embodiment of the present invention is formed by adding an yttria with a purity of 99% or more in an amount of 3 parts by weight or more and 100 parts by weight or less to 100 parts by weight of a cerium oxide having a purity of 99% or more, i.e., by adding an yttria powder with a purity of 99% or more to a ceria powder with a purity of 99% or more in an amount of 2.3 mol % or more and 43.2 mol % or less in the total composition, the resultant is molded, and then, the resultant is sintered at the temperature of not less than 1600° C. to not more than 1900° C.

The sintered body according to the second embodiment of the present invention is formed by adding an yttria powder with a purity of 99% or more to a ceria powder with a purity of 99% or more in an amount of 1 mol % or more and 50 mol % or less in the total composition, the resultant is molded, and then, the resultant is sintered at the temperature of not less than 1600° C. to not more than 1900° C.

The sintered body according to the third embodiment of the present invention is formed by adding a powder of a lanthanum oxide with a purity of 99% or more to a ceria powder with a purity of 99% or more in an amount of 1 mol % or more and 50 mol % or less in the total composition, the resultant is molded, and then, the resultant is sintered at the temperature of not less than 1600° C. to not more than 1900° C.

The specific manufacturing process of the sintered bodies according to the first to the third embodiments will be illustrated in the Examples below.

A sintering agent such as a binder may be added to the material powder as needed.

The sintering atmosphere may be a reducing atmosphere, an inert gas atmosphere, or ambient atmosphere.

In the component used in the plasma processing apparatus according to the present invention, at least the portion exposed to plasma is covered by a plasma sprayed film formed by adding an yttria with a purity of 99% or more in an amount of 3 parts by weight or more and 100 parts by weight or less to 100 parts by weight of a cerium oxide having a purity of 99% or more, i.e., a plasma sprayed film formed by adding an yttria with a purity of 99% or more to a cerium oxide with a purity of 99% or more in an amount of 2.3 mol % or more and 43.2 mol % or less in the total composition.

Specifically, the sprayed material of the sprayed film has the cerium oxide and yttria added to the cerium oxide in a predetermined amount, like the sintered body.

Therefore, the component covered by the sprayed film has the resistance to plasma like the sintered body, and even in a halogen plasma process, the contamination of a metal due to an impurity caused by the material of the sprayed film can be suppressed, compared to the conventional yttria ceramic sintered body.

The component covered by the sprayed film described above can be formed as described below. Specifically, a spraying material obtained by adding an yttria powder with a purity of 99% or more in an amount of 3 parts by weight or more and 100 parts by weight or less to 100 parts by weight of a ceria powder having a purity of 99% or more, i.e., a plasma sprayed film formed by adding an yttria with a purity of 99% or more to a cerium oxide with a purity of 99% or more in an amount of 2.3 mol % or more and 43.2 mol % or less in the total composition is used. The surface of the base, which is exposed to the plasma, is covered with a plasma spraying method in a predetermined thickness.

The specific manufacturing process is as described below in the Examples.

The plasma spraying method employs a plasma flame. Therefore, compared to a frame spraying method, the cerium oxide and yttria can sufficiently be melted and can be collided with the base with high speed, whereby the dense film can be formed. Thus, the plasma spraying method is preferable.

The present invention will be described more specifically with reference to the Examples, but the invention is not limited to the Examples described below.

### Example 1

50 parts by weight (27.5 mol % in the total composition of a sintered body) of yttria powders (Y₂O₃) with a purity of 99.2% were added to 100 parts by weight of ceria (CeO₂) powders with a purity of 99.5%, and a binder in an amount of 1 part by weight with respect to the ceria powders was added. The resultant was granulated by a spray dryer.

The obtained granulated powders were molded through the application of pressure under 1500 kgf/cm² with a cold isostatic press (CIP), and the resultant molded body was sintered at 1800° C. under hydrogen atmosphere to form a ceramic sintered body.

A focus ring was manufactured with the use of this sintered body.

### Examples 2, 3, Comparative Examples 1 to 4, Reference Example

Respective focus rings made of respective ceramic sintered bodies were manufactured in the same manner as in the Example 1 under the condition of the Examples 2 and 3, the Comparative Examples 1 to 4, and the Reference Example shown in Table 1 below.

### Example 4

A spray coating with a thickness of 200 μm was formed on the surface of an alumina focus ring, which is exposed to plasma, by using a spraying material obtained by adding 50 parts by weight (27.5 mol % in the total composition of a sintered body) of yttria powders (Y₂O₃) with a purity of 99.2% to 100 parts by weight of ceria (CeO₂) powders with a purity of 99.5%.

### Examples 5, 6, Comparative Examples 5 to 7

Spraying film was formed on the focus ring in the same manner as in the Example 4 under the condition of the Examples 5 and 6, and the Comparative Examples 5 to 7 shown in Table 1 below.

The porosity was measured in accordance with JIS R 1634 for each of the sintered bodies formed in the Examples and the Comparative Examples.

Further, a silicon wafer having a diameter of 200 mm was plasma-processed with an RIE etching apparatus (used gas: CHF₃, O₂, Ar mixture, upper electrode output: 2500 W, lower electrode output: 2000 W) by using the focus rings formed as described above, and then, the etching rate was measured. The number of dusts of 0.10 μm or more on the wafer was counted by a laser particle counter.

Table 1 shows the result of the measurement.

TABLE 1

| | Purity | | | Sintering | | Etching | Number |
|---|---|---|---|---|---|---|---|
| | of CeO₂ | Additive | | temperature | Porosity | rate | of |
| | (%) | amount of Y₂O₃ | Process | (° C.) | (%) | (μm/h) | Dust |
| Example 1 | 99.5 | 50 parts by weight | Sintering | 1800 | 0.5 | 0.05 | 3 |
| | | (27.5 mol %) | | | | | |
| Example 2 | 99.5 | 25 parts by weight | Sintering | 1800 | 0.4 | 0.08 | 3 |
| | | (16.0 mol %) | | | | | |
| Example 3 | 99.5 | 75 parts by weight | Sintering | 1800 | 0.7 | 0.04 | 2 |
| | | (36.3 mol %) | | | | | |
| Example 4 | 99.5 | 50 parts by weight | Spraying | — | 2.0 | 0.08 | 7 |
| | | (27.5 mol %) | | | | | |
| Example 5 | 99.5 | 25 parts by weight | Spraying | — | 1.8 | 0.10 | 8 |
| | | (16.0 mol %) | | | | | |
| Example 6 | 99.5 | 75 parts by weight | Spraying | — | 2.5 | 0.07 | 7 |
| | | (36.6 mol %) | | | | | |
| Comparative | 98 | 50 parts by weight | Sintering | 1800 | 4.0 | 0.17 | 20 |
| Example 1 | | (27.5 mol %) | | | | | |
| Comparative | 99.5 | 50 parts by weight | Sintering | 1550 | 5.0 | 0.20 | 24 |
| Example 2 | | (27.5 mol %) | | | | | |
| Comparative | 99.5 | 1 parts by weight | Sintering | 1800 | 0.6 | 0.20 | 16 |
| Example 3 | | (0.8 mol %) | | | | | |
| Comparative | 99.5 | 150 parts by weight | Sintering | 1550 | 0.8 | 0.04 | 4 |
| Example 4 | | (53.3 mol %) | | | | | |
| Comparative | 98 | 50 parts by weight | Spraying | — | 0.5 | 0.19 | 4 |
| Example 5 | | (27.5 mol %) | | | | | |
| Comparative | 99.5 | 1 parts by weight | Spraying | — | 1.8 | 0.40 | 15 |
| Example 6 | | (0.8 mol %) | | | | | |
| Comparative | 99.5 | 150 parts by weight | Spraying | — | 2.5 | 0.07 | 5 |
| Example 7 | | (53.3 mol %) | | | | | |
| Reference | 99.5 | 50 parts by weight | Sintering | 1950 | 0.4 | 0.05 | 3 |
| Example | | (27.5 mol %) | | | | | |

As shown in Table 1, it was confirmed that the ceramic sintered bodies (Examples 1 to 3) and the sprayed films (Examples 4 to 6) according to the present invention had low porosity. Therefore, it was confirmed that, when they were used for the component in the plasma processing apparatus, the component was excellent in resistance to plasma, and further, the generation of dusts could be prevented. Specifically, it was confirmed that the same satisfactory effect as in the case in which the additive amount of yttria was 150 parts by weight or more (Comparative Examples 4 and 7) could be obtained.

It is to be noted that the case in which the additive amount of yttria is 150 parts by weight or more (Comparative Examples 4 and 7) is non-preferable from the viewpoint of increased cost.

The ceramic component (Reference Example) formed by the sintering process at 1950° C. had low porosity, low etching rate, and low number of dusts, which meant that the result was satisfactory. However, it was broken, since the strength was insufficient.

### Example 7

Yttria powders (Y₂O₃) with a purity of 99.6% were added to ceria (CeO₂) powders with a purity of 99.5% in an amount of 15 mol % in the total composition, and a binder in an amount of 1 wt % with respect to the ceria powders was added. The resultant was granulated by a spray dryer.

The obtained granulated powders were molded through the application of pressure under 1500 kgf/cm² with a cold isostatic press (CIP), and the resultant molded body was sintered at 1800° C. under hydrogen atmosphere to form a ceramic sintered body.

### Example 8

A ceramic sintered body was manufactured in the same manner as in the Example 7, except that a lanthanum oxide (La₂O₃) with a purity of 99.3% was used instead of the yttria powders.

### Examples 9 to 14, Comparative Examples 8 to 13

Respective ceramic sintered bodies were manufactured in the same manner as in the Example 7 under the condition of the Examples 9 to 14 and the Comparative Examples 8 to 13 shown in Table 2 below.

TABLE 2

| | Purity | | Additive | | Sintering |
|---|---|---|---|---|---|
| | of CeO₂ | Added | amount | Sintering | Temperature |
| | (%) | component | (mol %) | atmosphere | (° C.) |
| Example 7 | 99.5 | Y₂O₃ | 15 | Hydrogen | 1800 |
| Example 8 | 99.5 | La₂O₃ | 15 | Hydrogen | 1800 |
| Example 9 | 99.5 | Y₂O₃ | 30 | Hydrogen | 1800 |
| Example 10 | 99.5 | Y₂O₃ | 45 | Hydrogen | 1800 |
| Example 11 | 99.5 | Y₂O₃ | 30 | Atmosphere | 1700 |
| Example 12 | 99.5 | La₂O₃ | 30 | Hydrogen | 1800 |
| Example 13 | 99.5 | La₂O₃ | 45 | Hydrogen | 1800 |
| Example 14 | 99.5 | La₂O₃ | 30 | Atmosphere | 1700 |
| Comparative | 98 | Y₂O₃ | 30 | Hydrogen | 1800 |
| Example 8 | | | | | |
| Comparative | 99.5 | Y₂O₃ | 30 | Hydrogen | 1550 |
| Example 9 | | | | | |
| Comparative | 99.5 | Y₂O₃ | 30 | Hydrogen | 1950 |
| Example 10 | | | | | |
| Comparative | 99.5 | Y₂O₃ | 0.5 | Hydrogen | 1800 |
| Example 11 | | | | | |
| Comparative | 99.5 | Y₂O₃ | 60 | Hydrogen | 1800 |
| Example 12 | | | | | |
| Comparative | 99.5 | Y₂O₃ | 30 | Hydrogen | 1800 |
| Example 13 | | | | | |

Various properties of the sintered bodies formed in the Examples and the Comparative Examples were evaluated with the method described below.

The porosity was measured in accordance with JIS R 1634.

The resistivity was measured in accordance with JIS K 6911 and JIS K 7194 at room temperature (20° C.).

Focus rings, which were made of the respective sintered bodies according to the Examples and the Comparative Examples, and which were subject to surface polishing in order that the surface roughness Ra of the portion exposed to plasma was 1.0 μm (2.0 μm in the Comparative Example 13).

Further, a silicon wafer having a diameter of 200 mm was plasma-processed with an RIE etching apparatus (used gas: CHF₄, O₂) by using the focus rings formed as described above, and then, the number of dusts of 0.15 μm or more on the wafer was counted by a laser particle counter.

Table 3 shows the result of the measurement.

TABLE 3

| | Surface | | Volume | |
|---|---|---|---|---|
| | roughness | Porosity | resistivity | Number of |
| | Ra (μm) | (%) | (Ωcm) | dust |
| Example 7 | 1.0 | Y₂O₃ | 1 × 10⁸ | 3 |
| Example 8 | 1.0 | La₂O₃ | 1 × 10⁹ | 3 |
| Example 9 | 1.0 | Y₂O₃ | 1 × 10⁶ | 3 |
| Example 10 | 1.0 | Y₂O₃ | 1 × 10⁹ | 2 |
| Example 11 | 1.0 | Y₂O₃ | 1 × 10¹⁰ | 4 |
| Example 12 | 1.0 | La₂O₃ | 1 × 10⁶ | 2 |
| Example 13 | 1.0 | La₂O₃ | 1 × 10⁹ | 4 |
| Example 14 | 1.0 | La₂O₃ | 1 × 10¹¹ | 6 |
| Comparative | 1.0 | Y₂O₃ | 1 × 10⁹ | 20 |
| Example 8 | | | | |
| Comparative | 1.0 | Y₂O₃ | 1 × 10¹¹ | 24 |
| Example 9 | | | | |
| Comparative | 1.0 | Y₂O₃ | 1 × 10⁸ | 4 |
| Example 10 | | | | |
| Comparative | 1.0 | Y₂O₃ | 1 × 10¹⁵ | 15 |
| Example 11 | | | | |
| Comparative | 1.0 | Y₂O₃ | 1 × 10¹⁴ | 25 |
| Example 12 | | | | |
| Comparative | 2.0 | Y₂O₃ | 1 × 10⁶ | 18 |
| Example 13 | | | | |

As shown in Table 3, it was confirmed that the ceramics (Examples 7 to 14) according to the present invention had low porosity and reduced volume resistivity. Therefore, it was confirmed that, when they were used for the component in the plasma processing apparatus, the component was excellent in resistance to plasma, and further, the generation of dusts could be prevented.

The ceramic sintered body (Comparative Example 10) formed by the sintering process at 1950° C. had low porosity, low volume resistivity, and low number of dusts, which meant that the result was satisfactory. However, it was broken, since the strength was insufficient.

What is claimed is:

1. A sintered body used in a plasma processing apparatus, which is formed by adding an yttria with a purity of 99% or more in an amount of 3 parts by weight or more and 100 parts by weight or less to 100 parts by weight of a cerium oxide having a purity of 99% or more.

2. A sintered body used in a plasma processing apparatus, which is formed by adding an yttria with a purity of 99% or more to a cerium oxide with a purity of 99% or more in an amount of 1 mol % or more and 50 mol % or less in the total composition, wherein the surface roughness Ra of the portion that is at least exposed to plasma is less than 1.6 μm.

3. A sintered body used in a plasma processing apparatus, which is formed by adding a lanthanum oxide with a purity of 99% or more to a cerium oxide with a purity of 99% or more in an amount of 1 mol % or more and 50 mol % or less in the total composition, wherein the surface roughness Ra of the portion at least exposed to plasma is less than 1.6 μm.

4. A sintered body used in a plasma processing apparatus according to any one of claims 1 to 3, wherein the porosity is 2% or less.

5. A sintered body used in a plasma processing apparatus according to claim 2 or claim 3, wherein the volume resistivity at 20 to 400° C. is 10 to 10¹² Ω·cm.

6. A sintered body used in a plasma processing apparatus according to any one of claims 1 to 3, which is sintered under 1600° C. or more and 1900° C. or less.

7. A component used in a plasma processing apparatus, wherein at least the portion exposed to plasma is covered by a sprayed film formed by adding an yttria with a purity of 99% or more in an amount of 3 parts by weight or more and 100 parts by weight or less to 100 parts by weight of a cerium oxide having purity of 99% or more.

8. A component used in a plasma processing apparatus according to claim 7, wherein the porosity of the sprayed film is 5% or less.
